(19) United States
(12) Patent Application Publication
(10) Pub. No.: US 2009/0142258 A1
(43) Pub. Date: Jun. 4, 2009

(54) PHYSIOCHEMICAL PATHWAY TO REVERSIBLE HYDROGEN STORAGE

(75) Inventors: James A. Ritter, Lexington, SC (US); Armin D. Ebner, Lexington, SC (US); Jun Wang, West Columbia, SC (US); Tao Wang, Erie, PA (US); Charles E. Holland, Cayce, SC (US)

Correspondence Address: DORITY & MANNING, P.A., POST OFFICE BOX 1449, GREENVILLE, SC, 29602-1449, US

(73) Assignee: University of South Carolina, Columbia, SC (US)

(21) Appl. No.: 11/993,036

(22) PCT Filed: Jun. 20, 2006
(86) PCT No.: PCT/US06/23914

§ 371 Date: Oct. 28, 2008

Related U.S. Application Data
(60) Provisional application No. 60/692,409, filed on Jun. 20, 2005.
(60) Provisional application No. 60/693,383, filed on Jun. 23, 2005.

(51) Int. Cl. C01B 6/24

(52) U.S. Cl. 423/646; 423/658.2; 423/647

(57) ABSTRACT

In one embodiment of the present disclosure, a process for cyclic dehydrogenation and rehydrogenation of hydrogen storage materials is provided. The process includes liberating hydrogen from a hydrogen storage material comprising hydrogen atoms chemically bonded to one or more elements to form a dehydrogenated material and contacting the dehydrogenated material with a solvent in the presence of hydrogen gas such that the solvent forms a reversible complex with rehydrogenated product of the dehydrogenated material wherein the dehydrogenated material is rehydrogenated to form a solid material containing hydrogen atoms chemically bonded to one or more elements.

### RELATED APPLICATIONS

The present application is based upon and claims priority to U.S. Provisional Patent Application No. 60/692,409, filed on Jun. 20, 2005 and to U.S. Provisional Patent Application No. 60/693,383, filed on Jun. 23, 2005

### STATEMENT AS TO RIGHTS TO INVENTIONS MADE UNDER FEDERALLY SPONSORED RESEARCH AND DEVELOPMENT

This invention was made with Government support under Contract No. DE-FC36-04GO14232 awarded by the United States Department of Energy. The Government has certain rights in the invention.

### BACKGROUND

Recently, considerable attention has been given to the use of hydrogen as a fuel or fuel supplement. While the world's oil reserves are being rapidly depleted, the supply of hydrogen remains virtually unlimited. Hydrogen is a relatively low cost fuel and has the highest density of energy per unit weight of any chemical fuel. Furthermore, hydrogen is essentially non-polluting since the main by-product of burning hydrogen is water. However, while hydrogen has enormous potential as a fuel, a major drawback in its utilization, particularly in automotive applications, has been the lack of an acceptable hydrogen storage medium.

Hydrogen storage in a solid matrix has become the focus of intense research because it is considered to be the only viable option for meeting performance targets set for such automotive applications. One of the more promising classes of hydrogen storage materials being studied is the complex hydrides, which includes the NaAlH₄ system.

The dehydrogenation of NaAlH₄ is thermodynamically favorable, but it is kinetically slow and takes place at temperatures well above 200° C. Dehydrogenation temperature and the kinetics of dehydrogenation can be markedly improved by the addition of a dopant or co-dopants, such as titanium chloride. Graphitic structures, such as fullerenes, diverse graphites and even carbon nanotubes, can also play an important role in improving the kinetics of dehydrogenation and reversibility of certain complex metal hydrides. Rehydrogenation of the NaAlH₄ system is typically carried out at greater than 100° C. and greater than 1,000 psig to achieve reasonable kinetics and conversions. While the NaAlH₄ system is attractive for hydrogen storage because it contains a relatively high concentration of useful hydrogen, the modest weight percent of hydrogen storage capacity is a major drawback toward commercial vehicular applications.

Other complex hydrides, such as LiAlH₄, have much better hydrogen storage capacities. However, some complex hydrides, including LiAlH₄, do not exhibit any reversibility under conditions that cause the NaAlH₄ system to easily rehydrogenate. Good reversibility and fast kinetics are both needed to enable hydrogen storage materials to be capable of repeated absorption-desorption cycles without significant loss of hydrogen storage capabilities and at reasonable charge and discharge rates.

Therefore, a need exists for a physiochemical pathway to reversible hydrogen storage in complex hydrides such as LiAlH₄. Transportation and stationary applications may become more feasible when such a physiochemical pathway is utilized in the development of a reversible H₂ storage material. SUMMARY

The present disclosure recognizes and addresses the foregoing needs as well as others. In one embodiment of the present disclosure, a process for cyclic dehydrogenation and rehydrogenation of hydrogen storage materials is provided. The process includes liberating hydrogen from a hydrogen storage material comprising hydrogen atoms chemically bonded to one or more elements to form a dehydrogenated material and contacting the dehydrogenated material with a solvent in the presence of hydrogen gas such that the solvent forms a reversible complex with rehydrogenated product of the dehydrogenated material wherein the dehydrogenated material is rehydrogenated to form a solid material containing hydrogen atoms chemically bonded to one or more elements.

In certain embodiments, the hydrogen storage material may include AlH₃, Bₓ(AlH₄)_{y}, Be(AlH₄)₂, Ca(AlH₄)₂, Ce(AlH₄)₂, CuAlH₄, Fe(AlH₄)₂, Ga(AlH₄)₃, In(AlH₄)₃, KAlH₄, LiAlH₄, Mg(AlH₄)₂, Mn(AlH₄)₂, NaAlH₄, Ti(AlH₄)₃, Ti(AlH₄)₄, Sn(AlH₄)₄, Zr(AlH₄)₄, Al(BH₄)₃, Ba(BH₄)₂, Be(BH₄)₂, Ca(BH₄)₂, Cd(BH₄)₂, Co(BH₄)₂, CuBH₄, Fe(BH₄)₂, Hf(BH₄)₄, KBH₄, LiBH₄, Mg(BH₄)₂, RbBH₄, NaBH₄, Sn(BH₄)₂, Sr(BH₄)₂, Na₃AlH₆, Na₂LiAlH₆, Ca₂FeH₆, Ca₄Mg₄Fe₃H₂₂, Mg₆Co₂H₁₁, Mg₂CoH₅, Mg₂FeH₆, LiMg₂RuH₇, Li₄RuH₆, SrMg₂FeH₈, Li₃Be₂H₇, NaMgH₃, LiBeH₃, Li₂BeH₄, LiBeH₄, Li₃Be₂H₅, Na₃RuH₇, Ti(BH₄)₃, U(BH₄)₄, Zn(BH₄)₂, Zr(BH₄)₄, Y(BH₄)₃, Sm(BH₄)₃, Eu(BH₄)₃, Gd(BH₄)₃, Tb(BH₄)₃, Dy(BH₄)₃, Ho(BH₄)₃, Er(BH₄)₃, Tm(BH₄)₃, Yb(BH₄)₃, and Lu(BH₄)₃. In some embodiments, the hydrogen storage material may include an aminoborane and ammonia borane complexes. In some embodiments, the hydrogen storage material may include a complex hydride material.

In some embodiments, the process may include adding one or more catalysts to said hydrogen storage material. In such embodiments, the catalyst may include metal chlorides, metal oxides, and metals.

In some embodiments, the process may include adding one or more chemical additives to said hydrogen storage material. In such embodiments, the chemical additive may include carbon, graphite, single wall carbon nanotubes, and multi-wall carbon nanotubes.

In some embodiments, the process may include ball milling the hydrogen storage material. In some embodiments, the process may include heating the hydrogen storage material to a temperature ranging from about 15° C. to about 500° C. to dehydrogenate hydrogen storage material. In some embodiments, the solvent may include tetrohydrofuran. In some embodiments, the process may include ball milling the solvent with the dehydrogenated material in the presence of hydrogen gas such that the dehydrogenated material is rehydrogenated. In some embodiments, the process may include sonochemically treating the solvent with the dehydrogenated material in the presence of hydrogen gas such that the dehydrogenated material is rehydrogenated.

In some embodiments, the process may include filtering the rehydrogenated material complexed with the solvent. In some embodiments, the process may include recovering the solvent for reuse during subsequent rehydrogenation cycles. In some embodiments, the process may be utilized to supply hydrogen to an internal combustion engine. In some embodiments, the process may be utilized to supply hydrogen to a fuel cell.

In another embodiment of the present disclosure, a process for synthesis of hydrogen storage materials is provided. The process includes providing one or more reactants and contacting the reactant with a solvent in the presence of hydrogen gas such that the solvent forms a reversible complex with the hydrogenated product of the reactant wherein the reactant is hydrogenated to form a solid material containing hydrogen atoms chemically bonded to one or more elements.

### DESCRIPTION OF THE DRAWINGS

A full and enabling disclosure, including the best mode thereof to one of ordinary skill in the art, is set forth more particularly in the remainder of the specification, including reference to the accompanying figures in which:

FIG. 1 sets forth thermally programmed desorption (TPD) (5° C./min) of A) NaAlH₄; B) LiAlH₄; and C) Mg(AlH₄)₂ systems when doped with TiCl₃ and ball milled.

FIG. 2 sets forth constant temperature desorption (CTD) at 90° C. of NaAlH₄, LiAlH₄, and Mg(AlH₄)₂ systems when doped with TiCl₃ and ball milled.

FIG. 3 sets forth A) Comparison of the TiCl₃ doped and ball milled NaAlH₄, LiAlH₄, and Mg(AlH₄)₂ systems during the first rehydrogenation cycle carried out in the Parr system at 125° C. and 1,200 pisg after being discharged of hydrogen at 125° C. and 50 psig for 16 hrs; and B) TPD at 5° C./min of the TiCl₃ doped and ball milled NaAlH₄, LiAlH₄, and Mg(AlH₄)₂ systems after carrying out 0 and 5 discharge (4 hrs) and charge (8 hrs) cycles in the Parr system between 50 and 1,200 psig at 125° C. for Na alanate ball milled 120 min, between 50 and 2,100 psig at 140° C. for Li alanate ball milled for 20 min, and between 50 and 1,500 psig at 150° C. for Mg alanate ball milled 15 min.

FIG. 4 sets forth temperature programmed desorption (TPD) curves (5° C./min) of 0.5 mol % Ti-doped LiAlH₄ obtained during one dehydrogenation/rehydrogenation cycle: a) after high pressure ball milling (HPBM) in H₂ at 97.5 bar for 20 minutes to disperse the Ti catalyst; b) after dehydrogenation at 90° C. for 5 hours to mimic use of the material in an application; c) after HPBM in H₂ at 97.5 bar for 2 hours after dehydrogenation in a futile attempt to rehydrogenate the sample under dry conditions; d) after HPBM in H₂ at 97.5 bar and 20 ml THF for 2 hours to rehydrogenation the sample under wet conditions, followed by filtration and drying, all being key steps in the physiochemical pathway; and (e) after HPBM in H₂ at 97.5 bar after the residue, obtained from the filtration step and which contains the Ti catalyst and un-converted reactants, was added back to the sample to complete the five-step cycle.

FIG. 5. sets forth x-ray diffraction (XRD) patterns of 0.5 mol % Ti-doped LiAlH₄ during one dehydrogenation/rehydrogenation cycle corresponding to the results in FIG. 4 and reference materials, showing the structural changes that occurred during various cycle steps and proving conclusively that LiAlH₄ was rehydrogenated according to the five-step physiochemical pathway: a) purified LiAlH₄ from Et₂O; b) rehydrogenated LiAlH₄; c) 0.5 mol % Ti-doped LiAlH₄ ball milled for 20 minutes in 97.5 bar of H₂; d) sample (c) decomposed at 90° C. for 5 hours; e) sample (d) ball milled for 2 hours in 97.5 bar of H₂; f) residue obtained from the filter paper after vacuum filtration of the regenerated sample; g) Li₃AlH₆ prepared mechanochemically from 2LiH+LiAlH₄; h) Al as received; and i) LiH as received.

FIG. 6. Schematic representation of the five-step physiochemical pathway for the cyclic dehydrogenation and rehydrogenation of LiAlH₄. The cycle steps consist of catalyst dispersion, dehydrogenation, rehydrogenation, vacuum filtration, and vacuum drying. The conditions listed are not exclusive and correspond to the typical results presented in FIG. 4 that were obtained for one complete cycle. The letters in the arrows correspond to the curves in FIG. 4.

FIG. 7 sets forth Curve A) a temperature programmed desorption (TPD) curve obtained at 2° C./min for the new hydrogen storage material comprised of LiBH₄, Al, B, MWNT, and TiCl₃ after the third charge cycle; Curve C) a TPD curve obtained at 2° C./min for the new hydrogen storage material comprised of LiBH₄, LiH, Al, B, MWNT, and TiCl₃ after the initial discharge; Curve B) is an RGA scan obtained at 8° C./min showing the hydrogen evolution during TPD.

FIG. 8 sets forth temperature programmed desorption (TPD) curves obtained at 2° C./min for the new hydrogen storage material comprised of LiBH₄, LiH, Al, B, MWNT, and TiCl₃. Curve a) sample charged with THF; Curve b) sample charged with a trace THF; Curve c) sample charged without THF; and curve d) risidual gas analyzer scan obtained at 8° C./min showing hydrogen evolution during TPD of sample depict in curve a.

FIG. 9 sets forth temperature programmed desorption (TPD) curves at 5° C./min showing the synthesis of NaAlH₄ from NaH, Al powder and 4 mol % TiCl₃: curve a) by ball milling for 2 hr at 1400 psig of H₂ in the absence of THF; and curve b) by ball milling for 2 hr at 1400 psig of H₂ in the presence of THF.

FIG. 10 sets forth temperature programmed desorption (TPD) curves at 5° C./min showing the synthesis of LiAlH₄ from LiH, Al powder and 4 mol % TiCl₃: curve a) by ball milling for 2 hr at 1400 psig of H₂ in the absence of THF; and curve b) by ball milling for 2 hr at 1400 psig of H₂ in the presence of THF.

FIG. 11. sets forth a temperature programmed desorption (TPD) curve at 2° C./min showing the synthesize of a new aluminum-boron complex hydride from LiAlH₄, TiCl₃ , Al powder and B powder: curve a) by charging in THF for 3 hr at 80 to 150° C. and 1400 psig of H₂; and curve b) risidual gas analyzer scan obtained at 8° C./min showing the hydrogen evolution during TPD.

### DETAILED DESCRIPTION

It is to be understood by one of ordinary skill in the art that the present discussion is a description of exemplary embodiments only, and is not intended as limiting the broader aspects of the present disclosure, which broader aspects are embodied in the exemplary construction.

In general, the present disclosure is directed to a physiochemical pathway to reversible hydrogen storage in complex hydrides. The physiochemical pathway approach could be used to foster reversibility in a wide variety of hydrogen storage materials, beyond complex hydrides. One class of such hydrogen storage materials are known as aminoboranes or ammonia borane complexes. Other classes of hydrogen storage materials also exist that the physiochemical pathway approach of the present disclosure can be utilized with.

In particular, the physiochemical route described herein enables regeneration of complex hydride materials that have previously resisted regeneration through more conventional methods. In addition, the physiochemical route described herein can lower the temperatures and pressures required for reversibility of materials that are regenerable by more conventional methods. The physiochemical route described herein can also lower the temperatures and pressures required for the synthesis of complex hydride materials. As used herein, regeneration refers to replacement of hydrogen that has been previously liberated from the complex hydride material. As used herein, synthesis refers to the formation of a complex hydride material from metals and metal hydrides of similar composition to the complex hydride.

More particularly, the physiochemical route described herein enables regeneration or synthesis of complex hydride material through the utilization of a complex-forming solvent which is amenable to fostering reversibility of high hydrogen capacity complex hydrides or lowering the temperatures and pressures for synthesis.

A complex hydride material can be formed by blending a metal hydride with another metal as would be known in the art. A catalyst can also be added. Suitable catalysts include TiCl₃ as a metal catalyst or any other suitable metal or non-metal catalyst as would be known in the art. In recent years, complex hydride materials have been examined for their potential to store hydrogen for use as a fuel.

In this regard, complex hydrides of interest can generally refer to alanate-based hydrides such as LiAlH₄, NaAlH₄, and MgAlH₄. Paricularly, complex hydrides which readily liberate hydrogen at moderate temperatures between 50° C.-200° C. and which yield a dehydrogenated form of hydride and have hydrogen storage capacity of at least 4 weight percent (wt. %=(100)(H)/(H+M)) are desireable in the present disclosure. Capacity herein is given as the fully hydrided value, that is, the highest hydrogen concentration measured in the hydride phase limit. It does not necessarily represent the reversible capacity for engineering purposes.

In some embodiments, complex hydrides can include boronate-based hydrides such as LiBIH₄. Paricularly, complex hydrides which readily liberate hydrogen at temperatures between 50° C.-500° C. and which yield a dehydrogenated form of hydride and have hydrogen storage capacity of at least 4 wt. % are desireable in the present disclosure.

A list of suitable complex hydrides and their corresponding wt. % hydrogen (theoretical) is provided in Table 1. This list is not meant to be exhaustive and only serves to list those complex hydrides with theoretical hydrogen capacities of 4 wt. % or greater. Any new complex hydrides yet to be created would also likely benefit from the physiochemical pathway taught by the present disclosure and can be utilized in accordance with the present disclosure.

As stated previously, the physiochemical route described in accordance with the present disclosure enables regeneration of complex hydride material that has previously resisted regeneration through more conventional methods. The physiochemical route described herein can also lower the temperatures and pressures required for reversibility of materials that are regenerable by more conventional methods. The physiochemical route described herein can also lower the temperatures and pressures required for the synthesis of complex hydride materials.

In one embodiment, the physiochemical route of the present disclosure can optionally begin with the complex hydride being purified. This purification step can occur immediately prior to blending with a catalyst and/or any co-dopants. Resistance to contaminants, which the complex hydride can be subjected to during manufacturing and utilization, can be performed to prevent a degradation of acceptable performance. Purification can take place with diethyl ether or any other suitable solvent as would be known to one of ordinary skill in the art. A complex hydride can be utilized as received, as well, with no purification necessary.

A complex hydride can also be blended with catalysts. Transition metals, such as Ti. Catalysts can be utilized in amounts ranging from 0-30 mol. %. Such catalysts have been shown to lower the temperature at which reasonable rates of dehydrogenation can occur. They have also been shown to increase the rate and lower the temperature at which hydrogenation can occur.

Co-dopants can also be blended with the complex hydride. In such embodiments, different transition metal and other metal dopants such as FeCl₃ and ZrCl₄ can be utilized in amounts ranging from 0-30 mol. %. Doping can occur sonochemically or by other methods known to one skilled in the art. It is believed that co-dopants can have synergistic effects which can benefit dehydrogenation/rehydrogenation kinetics both before and after cycling. In addition, effective amounts of other additives can also be added in an amount sufficient to protect dehydrogenation kinetics. Aluminum, boron, or other such additives can be blended with the complex hydride in amounts ranging from 0-50 wt. %.

A carbon source such as graphite can also be utilized as a co-dopant. Any suitable carbon source as would be known to one of ordinary skill in the art can be utilized. Graphitic structures, fullerenes, diverse graphites, and even single and multiwall carbon nanotubes, can also play an important role in improving the kinetics of dehydrogenation and reversibility of certain complex metal hydrides. Such a carbon source can be present in an amount ranging from 0-50 wt. %.

A complex hydride can undergo high energy action to reduce particle size and mix the materials. For instance, high energy ball milling can be utilized to reduce particle size and allow for mixing. High energy ball milling allows for a direct transfer of mechanical energy from a metal or ceramic ball to a material that it comes in contact with through high energy collisions. Such collisions can create intense localized stresses and strains that can induce structural changes and chemical reactions within the material, even at ambient temperature. Sonochemical treatment can be utilized in a similar manner to and in concert with high energy ball milling.

High energy ball milling can also take place under super-atmospheric pressure of H₂ gas. The pressure of the H₂ gas can range from just above atmospheric pressure to 2000 psig, but could be as high as 10,000 or even 20,000 psig. Such high energy ball milling can take place at room temperature. However, temperatures can vary depending on the inherent thermodynamics of the complex hydride. In some embodiments, such high energy ball milling can take place at an elevated temperature, for example, at 200° C. In some embodiments, such high energy ball milling can take place at even higher temperatures, such as 300° C., 400° C., or 500° C. In other embodiments, high energy ball milling can even take place at a cryogenic temperature, for example, at −196° C.

After such high energy ball milling, the complex hydride contains a high concentration of hydrogen and is useful to supply H₂. Hydrogen liberation yields a dehydrogenated form of hydride. A catalyst can also be utilized to aid in hydrogen liberation. Typically, such a dehydrogenated form of hydride cannot easily be regenerated with hydrogen and requires extreme conditions to rehydrogenate.

However, the present disclosure is amenable to fostering reversibility of complex hydrides. In accordance with one embodiment of the present disclosure, the dehydrogenated complex hydride can undergo high energy ball milling in the presence of a solvent. Such a solvent should be present in an amount sufficient to form a complex with the complex hydride. The solvent does not have to dissolve or even partially dissolve the complex hydride. The complex hydride can be completely insoluble in the solvent, as long as it forms a complex with the solvent. It is believed that the solvent lowers the activation energy required for reversibility. Any suitable solvent can be utilized so long as preferably a reversible complex with the complex hydride is formed. In some embodiments, the solvent complexes with the complex hydride in a one to one ratio while in other embodiments, the ratios can differ. An important aspect of the present disclosure is the ability of the solvent to form a weak complex with it, with the extent of this complexation extending from being simple solubility to being somewhat more energetic.

In one preferred embodiment, tetrohydrofuran (THF) can be utilized as the solvent to reversibly complex with the complex hydride. This can occur before, during, or after high energy ball milling. One aspect of the present disclosure can involve placing the discharged complex hydride to be reversed in the presence of some combination of one or more of the following: a hydrogen atmosphere, a complex forming solvent, and high energy ball milling (or the equivalent) to foster reversibility.

In embodiments where the complex hydride is LiAlH₄, four molecules of THF complex with one molecule of LiAlH₄. THF is present in an amount sufficient to at least partially form a complex with the complex hydride. The high energy ball milling can take place under sub- or super-atmospheric pressure of H₂ gas at pressures ranging from some vacuum below atmospheric pressure to just above atmospheric pressure to 400 psig. In some embodiments, pressures can be 2000 psig or to higher pressures, and high energy ball milling can take place at temperatures above or below room temperature.

The solvent/complex hydride reversible complex may need to be filtered to temporarily remove any solids such as catalyst or co-dopants. Such filtration can occur a number of ways as would be apparent to one of ordinary skill in the art.

A filtration step serves to decrease loss of hydrogen during drying. Such loss results from catalyst still being present during drying. In some embodiments, other separation methods that would be apparent to one of ordinary skill in the art can be used to remove solvent without causing dehydrogenation.

The reversible complex is then dried by methods as would be known in the art. Vacuum drying can be utilized. Drying can occur at temperatures below the decomposition temperature of the complex hydride, for example at 70° C. Cryogenic temperatures can also be utilized for freeze drying under vacuum. In such embodiments, excess solvent can be removed in this manner to result in a finished material.

In embodiments in which the reversible complex is filtered to temporarily remove any solids such as catalyst or co-dopants, such solids are blended back to the dried material for a finished material.

High energy ball milling of the finished material absent the solvent can also be utilized to create a doped and regenerated complex hydride. Such high energy ball milling can take place under sub- or super-atmospheric pressure of H₂ gas. The pressure of the H₂ gas can range from some vacuum below atmospheric pressure to just above atmospheric pressure to greater than 2000 psig.

Upon such high energy ball milling, the regenerated complex hydride can once again serve to supply H₂. Through the present disclosure, the hydrogen supply can be liberated and replenished repeatedly in the hydrogen storage material complex hydride.

In some embodiments, the hydrogen storage material can be incorporated into a fuel cartridge. In some embodiments, such a fuel cartridge could be used in connection with an internal combustion engine. In other embodiments, the fuel cartridge could be utilized in other automotive applications, e.g., with a fuel cell.

The outcome achieved using the physiochemical processing described herein for the lithium aluminum hydride material is perhaps the lowest temperature, highest capacity, reversible H₂ storage material known to date in the temperature ranges described. The unique feature of this physiochemical route is that it enables regeneration of this complex hydride material that has resisted regeneration through more conventional routes. In addition, the physiochemical route described herein can lower the temperatures and pressures required for reversibility of materials that are regenerable by more conventional methods, like sodium aluminum hydride. The physiochemical route described herein can also lower the temperatures and pressures required for the synthesis of complex hydride materials, like lithium aluminum hydride, sodium aluminum hydride and a new complex hydride comprised of lithium, aluminum and boron complexes with hydrogen.

Such a procedure, is amenable to fostering reversibility and synthesis of higher hydrogen capacity complex hydrides.

The advantages of the present disclosure may be better understood with reference to the following examples.

### EXAMPLE 1

The following example illustrates the how the LiAlH₄ system and the Mg(AlH₄)₂ system for hydrogen storage are not reversible when using the conventional means that works with the NaAlH₄ system. A study of the hydrogen release and uptake capability of Ti-doped NaAlH₄, LiAlH₄ and Mg(AlH₄)₂ as a function of Ti concentration, temperature, pressure, and cycle number was carried out. This was a systematic study of the dehydrogenation kinetics and cyclability of Ti doped LiAlH₄ and Mg(AlH₄)₂.

TiCl₃ (Aldrich, 99.99%, anhydrous), the catalyst precursor, was used as received. Crystalline NaAlH₄ (Fluka) was purified from a THF (Aldrich, 99.9%, anhydrous) solution and vacuum dried. The dried NaAlH₄ was mixed with TiCl₃ in THF to produce a doped sample containing up to 4 mole % Ti. The THF was evaporated while the NaAlH₄ and the catalyst were mixed manually for about 30 minutes using a mortar and pestle, or until the samples were completely dry. Crystalline LiAlH₄ in dry powder form (Aldrich, 95%) was also used as received. The LiAlH₄was dry mixed with TiCl₃ to produce a doped sample containing up to 2 Mole % Ti. Sufficiently pure Mg(AlH₄)₂, was also used as received. The Mg(AlH₄)₂ was dry mixed with TiCl₃ to produce a doped sample containing up to 2 mole % Ti. These mixtures were then ball milled for the desired time using a SPEX 8000 high-energy mill. All procedures were carried out in a nitrogen glove box.

A thermogravimetric analyzer (TGA) located in a nitrogen glove box was used to determine the dehydrogenation kinetics at atmospheric pressure using TPD and CTD modes. For TPD runs, the samples were heated to 250° C. at a ramping rate of 5° C./min under 1 atm of He, using an initial I min delay to ensure an environment of pure He. For CTD runs, a similar procedure was followed except that the samples were heated rapidly to the desired temperature and then held at this temperature for the desired time. Approximately 10 mg of sample were used in each TPD or CTD run.

A 3,000 psig Parr reactor, installed in an automated pressure and temperature cycling system, was used to evaluate sample rehydrogenation and cycling capabilities. The reactor conditions were continuously monitored and controlled with a computer. Samples were loaded into the reactor while in the glove box and then transferred to the cycling system. After completion of each rehydrogenation or cycling trial, the high pressure setting of hydrogen was maintained until the temperature was reduced to room temperature to prevent dehydrogenation. Pressure was then released and the sample was removed in the glove box for TGA studies.

Rehydrogenation studies were carried out with NaAlH₄ doped with 2 mole % Ti and ball milled 120 min, LiAlH₄ doped with 2 mole % Ti and ball milled for 20 min, and Mg(AlH₄)₂ doped with 1 mole % Ti and ball milled 15 min. For all three alanates, a first rehydrogenation attempt was carried out in the Parr system at 125° C. and 1,200 psig after being discharged of hydrogen at 125° C. and 50 psig for 16 hrs; TPD was done afterwards. TPD was also done on all samples after carrying out 0 and 5 dehydrogenation (4 hrs) and rehydrogenation (8 hrs) cycles between 50 and 1,200 psig at 125° C. for Na alanate, between 50 and 2,100 psig at 140° C. for Li alanate, and between 50 and 1,500 psig at 150° C. for Mg alanate in the Parr reactor system.

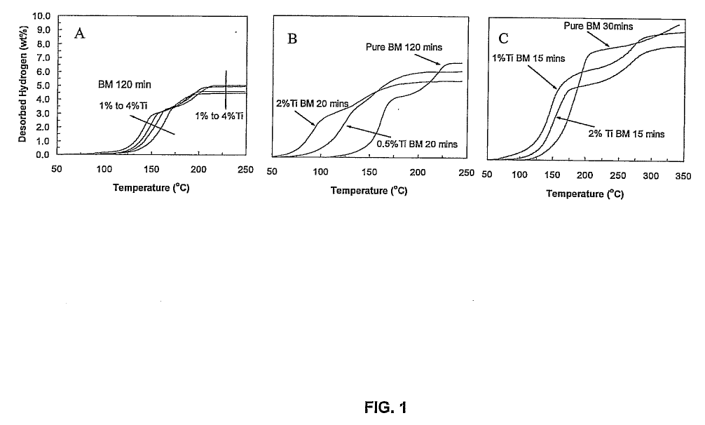

The results shown in FIG. 1 provide a comprehensive comparison of the effect of Ti as a dopant on the dehydrogenation of NaAlH₄, LiAlH₄ and Mg(AlH₄)₂ complex hydrides. FIG. 1A displays the typical behavior of the dehydrogenation of NaAlH₄ doped with 1 to 4 mole % Ti during TPD, after being balled milled for 120 min. The first plateau region corresponds to hydrogen being released according to the decomposition reaction in Eq. 1, whereas the second plateau region corresponds to the decomposition reaction in Eq. 2.

3NaAlH₄→Na₃AlH₆+2Al+3H₂ (1)

Na₃AlH₆→3NaH+Al+3/2H₂. (2)

In the first case, about 3 wt % hydrogen is released and in the second case about 2 wt % hydrogen is released, with the total being about 5 wt % hydrogen. For the first reaction, the release rate is faster and occurs at a lower temperature with increasing Ti concentration. The Ti also has a more pronounced effect on the first reaction than the second reaction. Note that without the Ti dopant present, the decomposition reaction in Eq. 1 would not begin to yield any hydrogen until about 230° C. or so. This 3 wt % hydrogen release is essentially state-of-the-art for this system.

FIG. 1B displays the behavior of the dehydrogenation of LiAlH₄ during TPD for an undoped sample ball milled for 120 min, and for two samples doped with 0.5 and 2 mole % Ti and each ball milled for 20 min. Again, the first plateau region corresponds to hydrogen being released according to the reaction in Eq. 3, whereas the second plateau region corresponds to the reaction in Eq. 4.

3LiAlH₄→Li₃AlH₆+2Al+3H₂ (3)

Li₃AlH₆→3LiH+Al+3/2H₂ (4)

In the first case, about 3 to 5 wt % hydrogen is released, and in the second case about 3 to 4 wt % hydrogen is released, both being dependent on the dopant level and ball milling time, with the total being 6 to 7 wt % hydrogen. The effect of the Ti dopant is pronounced in this case. Increasing the dopant level causes hydrogen to be released at a lower temperature, but also in smaller amounts. Doping with 0.5 mole % Ti consistently yields a decrease of around 50° C. in the overall dehydrogenation temperature. Increasing the dopant level further to 2 mole % Ti yields an initial decomposition temperature similar to that obtained for the sample doped with 0.5 mole % Ti; however, the overall dehydrogenation temperature is lowered by about 25° C. The Ti dopant also affects the first reaction more than the second reaction, similarly to the NaAlH₄ system. Stability of the LiAlH₄ system, whether doped or not, does not seem to be a major issue. Note that when LiAlH₄ is doped with 2 mole % Ti, it releases 3 wt % hydrogen before 100° C. is reached. The NaAlH₄ system, even when doped with 4 mole % Ti, does not begin to release hydrogen until about 100° C. This makes the LiAlH₄ attractive for hydrogen storage if it can be made to rehydrogenate.

FIG. 1C displays the behavior of the dehydrogenation of Mg(AlH₄)₂ during TPD for an undoped sample ball milled for 30 min, and for two samples doped with 1 and 2 mole % Ti and each ball milled for 15 min. Again, the first plateau region corresponds to hydrogen being released according to the reaction in Eq. 5, whereas the second plateau region corresponds to the reaction in Eq. 6.

Mg(AlH₄)₂→MgH₂+2Al+3H₂ (5)

MgH₂→Mg+H₂ (6)

In the first case, about 6 to 8 wt % hydrogen is released, and in the second case about 1 to 3 wt % hydrogen is released, both being dependent on the dopant level and ball milling time, with the total being 8 to 9 wt % hydrogen. The effect of the Ti dopant is again quite pronounced, but not as pronounced as the LiAlH₄ system. However, 1 mole % Ti does better than 2 mole %; this interesting effect has not been observed with either the NaAlH₄ or LiAlH₄ system. Nevertheless, at about 60° C., the doped samples begin to release hydrogen with significant amounts being released below 150° C. Hence, Mg(AlH₄)₂ doped with 1 mole % Ti and ball milled for 15 minutes exhibits the improved dehydrogenation kinetics, releasing over 5 wt % hydrogen below 150° C.

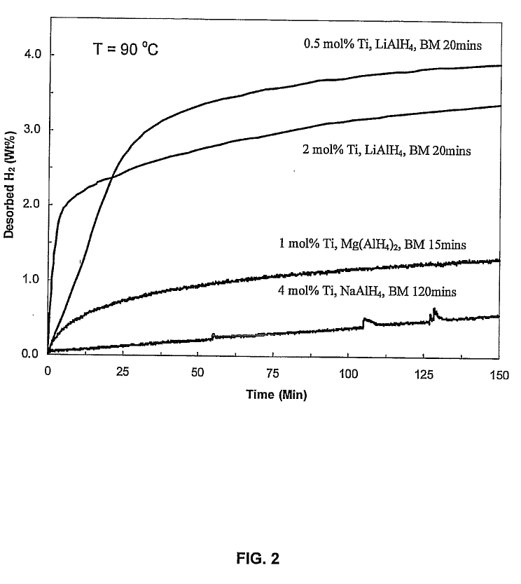

FIG. 2 shows the CTD curves obtained at 90° C. for samples of NaAlH₄ ball milled for 120 min and doped with 4 mole % Ti, LiAlH₄ ball milled for 20 minutes and doped with 0.5 and 2 mole % Ti, and Mg(AlH₄)₂ ball milled for 15 min and doped with 1 mole % Ti. The relative hydrogen release rates of these doped complex hydride materials is quite clear. In 150 min, the sodium alanate releases less than 0.5 wt % hydrogen, and the magnesium alanate releases less than 1.5 wt % hydrogen, both being comparable and slow at this temperature. In contrast, the lithium alanate sample doped with 0.5 mole % Ti yields 3 wt % hydrogen within 30 min, while the sample doped with 2 mole % Ti yields 2 wt % loss hydrogen within 6 min, exceedingly fast rates compared to the sodium and magnesium systems. Although the dehydrogenation rate of the LiAlH₄ sample doped with 2 mole % Ti is significantly greater than that associated with the LiAlH₄ sample doped with 0.5 mole % Ti, the latter has a greater yield of hydrogen due to the lower dopant level. For hydrogen storage, these results make the LiAlH₄ system look very attractive and the Mg(AlH₄)₂ system look somewhat attractive compared to the NaAlH₄ system.

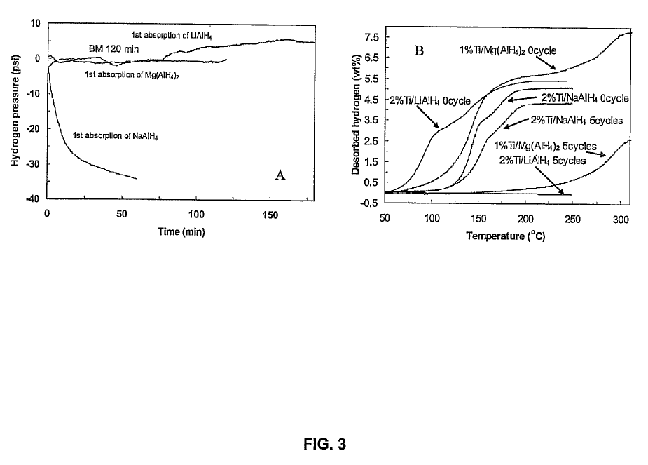

FIG. 3A compares the NaAlH₄, LiAlH₄, and Mg(AlH₄)₂ systems during the first rehydrogenation cycle carried out in the Parr cycling system at 125° C. and 1,200 psig after being discharged of hydrogen at 125° C. and 50 psig for 16 hrs. The uptake of hydrogen for the Na alanate system is evident by the pressure decreasing with time in this closed system. However, no pressure changes are observed with the Li and Mg alanate systems, indicating no uptake of hydrogen after one discharge and charge cycle at these conditions. TPD runs after 0 and 5 dehydrogenation/rehydrogenation cycles with the Na, Li and Mg alanate systems are shown in FIG. 3B. The Na system is clearly reversible with the typical loss in capacity of about 1 wt % observed after several cycles. In contrast, the Li alanate system shows no uptake of hydrogen even after five cycles; and although the Mg alanate system shows some release of hydrogen at about 250° C. after 5 cycles, this release is primarily from the second reaction in Eq. 6, which is never fully dehydrogenated at the cycling temperature employed here. Hence, neither Li nor Mg exhibit any reversibility under conditions that causes the Na system to rehydrogenate, even after 5 cycles.

Overall, it was found that Li alanate can be dry doped with 2 mole % Ti and ball milled for up to 20 minutes with only minor hydrogen losses. LiAlH₄ doped with as little as 0.5 mole % Ti exhibited dehydrogenation rates at 90° C. that were far superior to those exhibited by NaAlH₄ at 125° C., even when doped with 4 mole % Ti. However, Ti doped LiAlH₄ was found to be irreversible at conditions where Ti doped NaAlH₄ is easily rehydrogenated, i.e., at 125° C. and 1,200 psig.

It was also found that ball milling and Ti as a catalyst increased the dehydrogenation kinetics of Mg(AlH₄)₂, with very high hydrogen capacities and reasonable dehydrogenation rates exhibited at 150° C. However, Ti doped Mg(AlH₄)₂ was found to be irreversible at conditions where Ti doped NaAlH₄ is easily rehydrogenated, i.e., at 125° C. and 1,200 psig. These are key results where to date, only the NaAlH₄ system has been shown to be reversible at reasonable temperatures and pressures within the complex hydride class of hydrogen storage materials, with many examples provided in Table 1.

### EXAMPLE 2

### Regeneration of Lithium Aluminum Hydride in Tetrahydrofuran from its Decomposition products of LiAlH₆, Al and LiH

The following example illustrates the physiochemical route of the present disclosure with the complex hydride, lithium aluminum hydride. This pathway was used to make the complex hydride, lithium aluminum hydride, into a low temperature (<150° C.) 5 to 6 wt % reversible H₂ storage material. Moreover, this material reversibly stores around 3 to 4 wt % H₂ at around 100° C.

TiCl₃ (Aldrich, 99.99%, anhydrous),and LiH (Aldrich, 95%) were used as received. LiAlH₄ powder (Aldrich, 95%) was re-crystallized from a 3 M diethyl ether (Et₂O) (Aldrich, 99.9%, anhydrous) solution, filtered through 0.7 μm filter paper, and vacuum-dried. The typical procedure associated with carrying out one dehydrogenation/rehydrogenation cycle with LiAlH₄ proceeded as follows.

Step 1. 1 g of LiAlH₄ was mixed with the catalyst precursor (TiCl₃) to produce a doped sample containing up to 4 mol % metal relative to Na. The sample was then ball milled for 20 minutes at different hydrogen pressures (National Welders, UHP, 99.995%) ranging from 4.5 to 97.5 bar using a SPEX 8000 high-energy ball mill loaded with a 65 cm³ SS vial containing a single SS ball (8.2 g) with a diameter of 1.3 cm.

Step 2. After ball-milling, the sample was subjected to dehydrogenation by heating at 90° C. for 5 hours.

Step 3. The dehydrogenated sample was then ball milled for 2 hours at different hydrogen pressures ranging from 4.5 to 97.5 bar. Afterwards, tetrahydrofuran (THF) (Aldrich, 99.9%, anhydrous) ranging from 2.5 to 20 ml was added to this sample and the mixture was ball milled for an additional 2 hours at different hydrogen pressures ranging from 4.5 to 97.5 bar.

Step 4. The resulting heterogeneous mixture containing both soluble and insoluble compounds was vacuum filtered through 0.7 μm filter paper and vacuum dried to collect the rehydrogenated LiAlH4 from the dehydrogenated material as a precipitate from the filtrate.

Step 5. The residue remaining on the filter paper, consisting of insoluble reactants and catalyst, was collected and used to re-dope the sample with catalyst as the final step in the physiochemical pathway.

All sample handling procedures were performed in a nitrogen glove box. The conversion was calculated based on the amount of sample obtained from the filtrate after rehydrogenation divided by the total amount of sample collected after the rehydrogenation step, including the filtrate plus the residue on the filter paper. Thermogravimetric analysis was carried out with a Perkin Elmer TGA 7 Series thermogravimetric analyzer (TGA). The dehydrogenation rates of various doped and ball milled samples of LiAlH₄ were measured at atmospheric pressure in helium (National Welders, UHP, 99.995%) flowing at ˜60 cm³/min in a temperature programmed desorption (TPD) mode. For TPD runs, the samples were heated to 250° C. at a ramping rate of 5° C./min after purging with helium for 1 minute. Approximately 10 mg of sample were used in each TPD run.

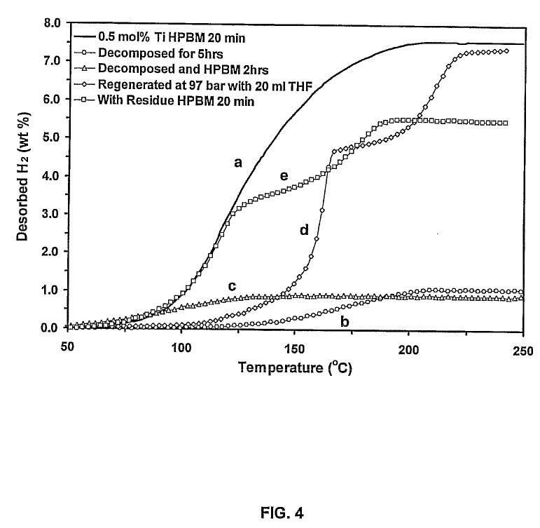

Typical results obtained from the physiochemical pathway are shown in FIG. 4. This figure shows temperature programmed desorption (TPD) curves (5° C./min) of 0.5 mol % Ti-doped LiAlH₄ obtained during one dehydrogenation/rehydrogenation cycle: a) after high pressure ball milling (HPBM) in H₂ at 97.5 bar for 20 minutes to disperse the Ti catalyst; b) after dehydrogenation at 90° C. for 5 hours to mimic use of the material in an application; c) after HPBM in H₂ at 97.5 bar for 2 hours after dehydrogenation in a futile attempt to rehydrogenate the sample under dry conditions; d) after HPBM in H₂ at 97.5 bar and 20 ml THF for 2 hours to rehydrogenation the sample under wet conditions, followed by filtration and drying, all being key steps in the physiochemical pathway; and (e) after HPBM in H₂ at 97.5 bar after the residue, obtained from the filtration step and which contains the Ti catalyst and un-converted reactants, was added back to the sample to complete the five-step cycle.

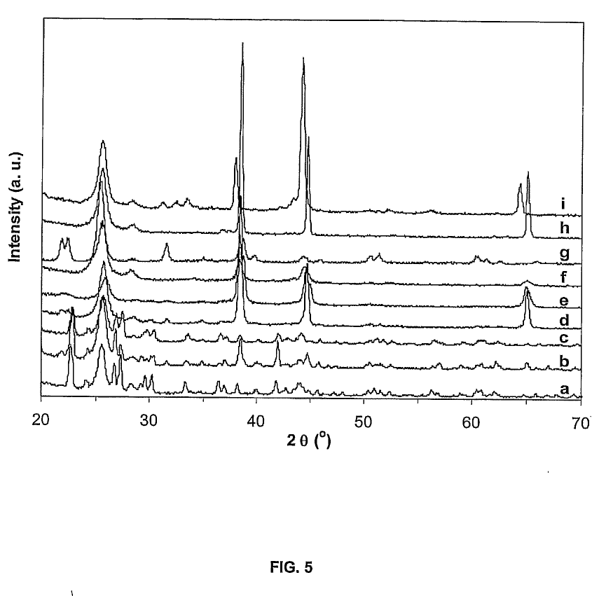

To conclusively verify that LiAlH₄ was being formed from its decomposition products, the progress of the physiochemical pathway was followed using x-ray diffraction (XRD). The results are shown in FIG. 5 shows, which displays XRD patterns of 0.5 mol % Ti-doped LiAlH₄ during one dehydrogenation/rehydrogenation cycle corresponding to the results in FIG. 4 and reference materials. The results in this figure show the structural changes that occurred during various cycle steps and proving conclusively that LiAlH₄ was rehydrogenated according to the five-step physiochemical pathway: a) purified LiAlH₄ from Et₂O; b) rehydrogenated LiAlH₄; c) 0.5 mol % Ti-doped LiAlH₄ ball milled for 20 minutes in 97.5 bar of H₂; d) sample (c) decomposed at 90° C. for 5 hours; e) sample (d) ball milled for 2 hours in 97.5 bar of H₂; f) residue obtained from the filter paper after vacuum filtration of the regenerated sample; g) Li₃AlH₆ prepared mechanochemically from 2LiH+LiAlH₄; h) Al as received; and i) LiH as received.

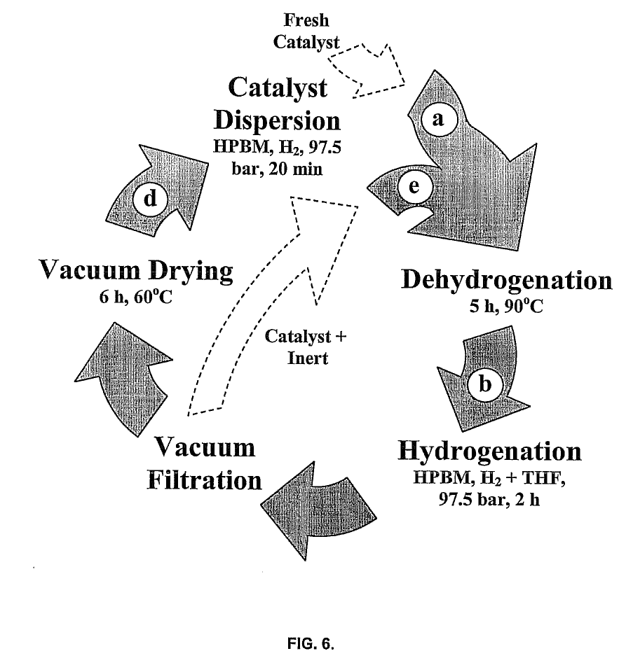

The results in FIGS. 4 and 5 systematically demonstrate a physiochemical pathway that makes lithium aluminim hydride reversible by the procedure outlined in Example 2. A schematic representation of the five-step physiochemical pathway for the cyclic dehydrogenation and rehydrogenation of LiAlH₄ is shown in FIG. 6. The cycle steps in this example consist of catalyst dispersion, dehydrogenation, rehydrogenation, vacuum filtration, vacuum drying, and then catalyst re-dispersion. This last step begins the first step of the second cycle and so on. Note that fresh catalyst or preferably catalyst recovered from the filtration step as insoluble residue may be used. The THF can also be easily recovered and reused. At very high conversions this cycle represents a closed loop requiring only energy input for the cyclic dehydrogenation and rehydrogenation of LiAlH₄, a potential hydrogen storage material. The conditions listed are not exclusive and correspond to the typical results presented in FIG. 4 that were obtained for one complete cycle. The cycle steps listed are also not exclusive and correspond to one example of many possible variations of the physiochemical pathway approach. The letters in the arrows correspond to the curves in FIG. 4.

### EXAMPLE 3

### Preparation, Dehydrogenation and Rehydrogenation of a New Complex Hydride Hydrogen Storage Material

TiCl₃ (Aldrich, 99.99%, anhydrous), aluminum powder (Alfa Aesar, 99.97%), LiH (Alfa Aesar, 99.4% metals basis), multiwall carbon nanotubes (MWNT, Aldrich, 20-40 nm), lithium boron hydride (Acros, 95%), boron powder (Alfa Aesar, 99%), and tetrahydrofuran (THF) (Aldrich, 99.9%, anhydrous) were used as received. All sample handling procedures were performed in a nitrogen glove box.

Step 1. LiBH₄ and the catalyst precursor (TiCl₃) were mixed in certain proportions with Al powder, LiH, MWNT and THF. About 1 g of sample was loaded into a 65 cm3 SS vial, along with a single SS ball (8.2 g) having a diameter of 1.3 cm. It was ball milled in this vial for 100 to 120 minutes at room temperature using a SPEX 8000 high-energy ball mill.

Step 2. After ball-milling, the sample was placed in a tube furnace that had an inert gas flowing through it. It was then heated to 450° C. and held there for 3 hr to completely discharge (decompose) the sample of its hydrogen.

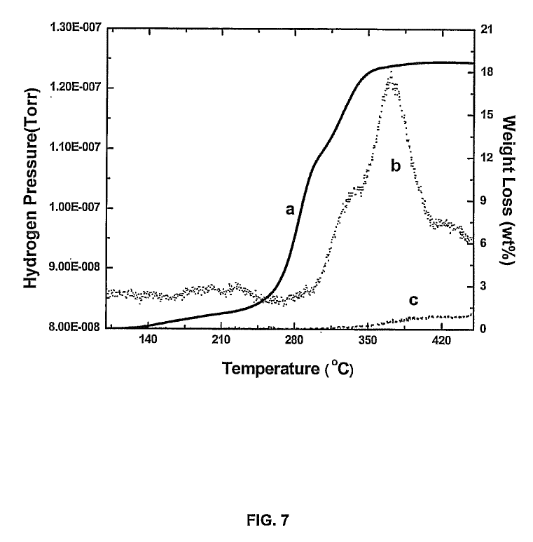

Step 3. This discharged sample constitutes another variation of the hydrogen storage material. It was stored in a vial inside the nitrogen glove box for further testing. The resulting temperature programmed desorption (TPD) curve of this discharged sample is shown in FIG. 7 (curve c).

Step 4. Some aluminum powder was added to the dehydrogenated sample and ball milled for 10 to 15 minutes. The sample was placed in the constant temperature cycling reactor along with a few drops of THF. The reactor was sealed. The sample was then heated to between 80 and 150° C. under 1400 psig of H₂ and held at these conditions for 3 hours to rehydrogenate it.

Step 5. The sample was removed from the reactor, taken into the nitrogen glove box, and vacuum dried at 130° C. for 5 hours to remove the THF. A tiny portion (˜20 mg) of the sample was removed for testing. The resulting temperature programmed desorption (TPD) curve is shown in FIG. 7 (curve a), along with an analysis of the discharge gas from a residual gas analyzer (RGA) (curve b). Curves a anb b indicate that some, if not all, of the weight loss was due to the generation of hydrogen.

Step 6. The sample can be cycled by carrying out the dehydrogenation and rehydrogenation steps outlined above.

### EXAMPLE 4

### Preparation, Dehydrogenation and Rehydrogenation of a New Complex Hydride Hydrogen Storage Material

Step 1. Preparation and steps 1, 2 and 3 are the same as in Example 3.

Step 2. The dehydrogenated sample was placed in the constant temperature cycling reactor along with a few drops of THF. The reactor was sealed. The sample was then heated to between 80 and 150° C. under 1400 psig of H₂ and held at these conditions for 3 hours to rehydrogenate it.

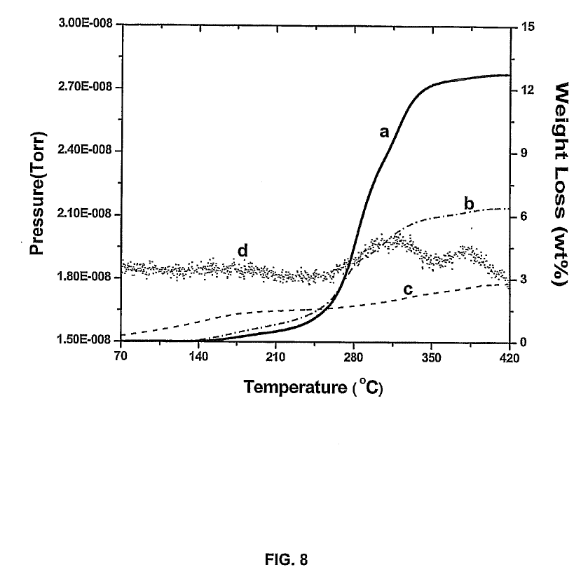

Step 3. The sample was removed from the reactor, taken into the nitrogen glove box, and vacuum dried at 130° C. for 5 hours to remove the THF. A tiny portion (˜20 mg) of the sample was removed for testing. The resulting temperature programmed desorption (TPD) curve is shown in FIG. 8 (curve a), along with an analysis of the discharge gas from a residual gas analyzer (RGA) (curve d).

Step 4. The sample can be cycled by carrying out the dehydrogenation and rehydrogenation steps.

### EXAMPLE 5

### Preparation, Dehydrogenation and Rehydrogenation of a New Complex Hydride Hydrogen Storage Material

Step 1. Preparation and steps 1, 2 and 3 are the same as in Example 3.

Step 2. The dehydrogenated sample was placed in the constant temperature cycling reactor along with a trace of THF. The reactor was sealed. The sample was then heated to between 80 and 150° C. under 1400 psig of H₂ and held at these conditions for 3 hours to rehydrogenate it.

Step 3. The sample was removed from the reactor, taken into the nitrogen glove box, and vacuum dried at 130° C. for 5 hours to remove the THF. A tiny portion (˜20 mg) of the sample was removed for testing. The resulting temperature programmed desorption (TPD) curve is shown in FIG. 8 (curve b).

Step 4. The sample can be cycled by carrying out the dehydrogenation and rehydrogenation steps.

### EXAMPLE 6

### Preparation, Dehydrogenation and Rehydrogenation of a New Complex Hydride Hydrogen Storage Material

Step 1. Preparation and steps 1, 2 and 3 are the same as in Example 3.

Step 2. The dehydrogenated sample was placed in the constant temperature cycling reactor without any solvent. The reactor was sealed. The sample was then heated to between 80 and 150° C. under 1400 psig of H₂ and held at these conditions for 3 hours to rehydrogenate it.

Step 3. The sample was removed from the reactor, taken into the nitrogen glove box, and vacuum dried at 130° C. for 5 hours to mimic removing the THF, even though there was none present. A tiny portion (˜10 mg) of the sample was removed for testing. The resulting temperature programmed desorption (TPD) curve is shown in FIG. 8 (curve c).

Step 4. The sample can be cycled by carrying out the dehydrogenation and rehydrogenation steps.

The results in FIGS. 7 and 8 demonstrate another physiochemical pathway that makes a new complex hydride reversible by the procedure outlined in Examples 3 to 6. This physiochemical is simpler than the pathway for the cyclic dehydrogenation and rehydrogenation of LiAlH₄ shown in FIG. 6 because ball milling is not necessary during rehydrogenation and filtration is not necessary to remove the catalysts and additives. The cycle steps in these examples consist of catalyst dispersion, dehydrogenation, rehydrogenation, and vacuum drying. This last step begins the first step of the second cycle and so on. Again, the THF can also be easily recovered and reused. At very high conversions this cycle represents a closed loop requiring only energy input for the cyclic dehydrogenation and rehydrogenation of this new complex hydride, a potential hydrogen storage material.

The amount of hydrogen produced from these higher temperature complex hydride materials that are based on Li, Al and B chemistry varies considerably depending on many factors, such as the Al to B ratio. For example, although it is clear from the RGA scan shown in FIG. 7 that hydrogen is evolved during dehydrogenation, the exceedingly high weight loss exhibited by this material cannot all be due to hydrogen and is due to the presence of other compounds like B₂H₆. The RGA detects the present B₂H₆ in the evolved gases in some cases and in other cases it does not. For example, no B₂H₆ or any other compounds except for hydrogen were detected by the RGA during the dehydrogenation of the materials shown in FIG. 8, indicating the possibility that only hydrogen was produced at a very high weight percentage.

### EXAMPLE 7

### Synthesis of Sodium Aluminum Hydride in Tetrahydrofuran from Sodium Hydride, Aluminum, Titanium Chloride and Hydrogen

TiCl3 (Aldrich, 99.99%, anhydrous), aluminum powder (Alfa Caesar, 99.97%), NaH (Aldrich, 95%), and tetrahydrofuran (THF) (Aldrich, 99.9%, anhydrous) were used as received. All sample handling procedures were performed in a nitrogen glove box.

Step 1. 0.44 g of NaH and 0.5 g of Al powder were mixed with the catalyst precursor (TiCl₃) to produce a doped sample containing 4 mol % metal (a dry doping procedure). The sample was ball milled for 2 hr under 1400 psig of H₂ at room temperature using a SPEX 8000 high-energy ball mill using a 65 cm3 SS vial. The vial was loaded with 1 g of doped complex hydride powder and a single SS ball (8.2 g) with a diameter of 1.3 cm. A tiny portion (˜10 mg) of the sample was removed for testing. The resulting temperature programmed desorption (TPD) curve is shown in FIG. 8a.

Step 2. After ball-milling, 20 ml of THF was added to the sample and transferred to the high pressure SS vial. The sample was then ball milled again under 1400 psig of H₂ for another 2 hr at room temperature.

Step 3. The solution containing the sample was filtered through 0.7 μm filter paper. The filtrate was clear but black in color, indicating that it contained a soluble species or a suspended black solid. The filtrate was vacuum-dried at 80° C. 0.662 g of solid was collected. A tiny portion (˜10 mg) of the sample was removed for testing. The resulting TPD curve is shown in FIG. 8b.

### EXAMPLE 8

### Synthesis of Lithium Aluminum Hydride in Tetrahydrofuran from Lithium Hydride, Aluminum Powder, Titanium Chloride and Hydrogen

TiCl3 (Aldrich, 99.99%, anhydrous), aluminum powder (Alfa Caesar, 99.97%), LiH (Alfa Aesar, 99.4% (metals basis)), and tetrahydrofuran (THF) (Aldrich, 99.9%, anhydrous) were used as received. All sample handling procedures were performed In a nitrogen glove box.

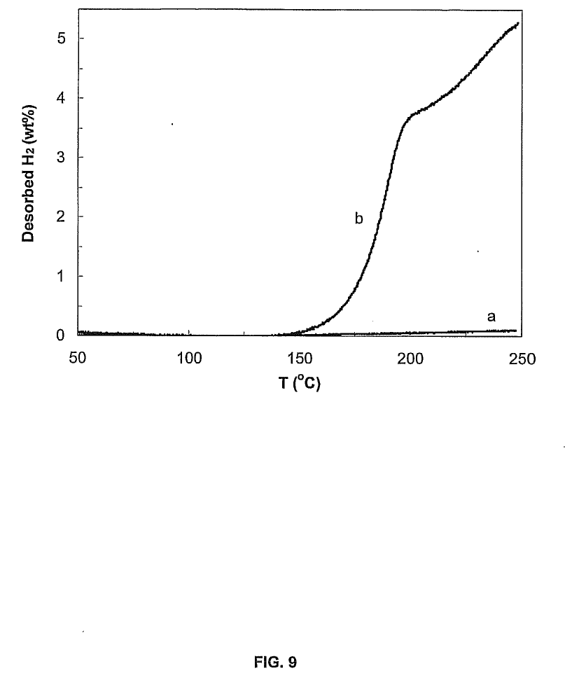

Step 1. 0.21 g of LiH and 0.71 g of Al powder were mixed with the catalyst precursor TiCl3 (0.0204 g) to produce a doped sample containing 0.5 mol % metal (a dry doping procedure). The sample was ball milled for 2 hr at room temperature using a SPEX 8000 high-energy ball mill using a 65 cm3 SS vial containing 1 g of powder and a single SS ball (8.2 g) with a diameter of 1.3 cm. A tiny portion (˜10 mg) of the sample was removed for testing. The resulting TPD curve is shown in FIG. 9a.

Step 2. After ball-milling, 20 ml THF were added to the sample and transferred to the high pressure SS vial. The sample was then ball milled again under 1400 psig of H₂ for another 2 hr at room temperature.

Step 3. The solution containing the sample was filtered through 0.7 μm filter paper. The filtrate was clear but black in color, indicating that K contained a soluble species or a suspended black solid. The filtrate was vacuum-dried at 60° C. 0.75 gram solid of were collected. A tiny portion (˜10 mg) of the sample was removed for testing. The resulting TPD curve is shown in FIG. 9b.

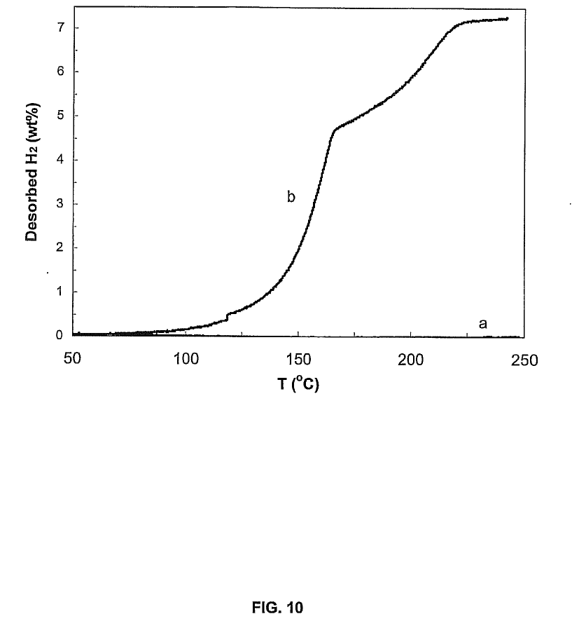

The results in FIGS. 9 and 10 systematically demonstrate a physiochemical pathway for the synthesis of sodium aluminim hydride and lithium aluminum hydride at room temperature and a moderate hydrogen pressure according to the procedure outlined in Examples 7 and 8, respectively. These results verify that the procedure outlined in Examples 7 and 8 foster the synthesis of sodium aluminim hydride and lithium aluminim hydride, respectively. This is explained below.

The reactions that took place while carrying out the procedures outlined In Examples 7 and 8 were understood to be, respectively:

NaH+Al+3/2H₂→NaAlH₄ (1)

LiH+Al+3/2H₂→LiAlH₄ (2)

where the TiCl₃ served as a catalyst and the THF served as a solvent and a complexing or adduct-forming agent. The novelty was that these reactions took place under relatively mild synthesis conditions of room temperature and 1400 psig of H₂. Accordingly, NaAlH₄ or LiAlH₄ can be made through the physiochemical pathway (doped with Ti or not, with the former making it a reversible hydrogen storage material) by simply starting with the corresponding metal hydride (NaH or LiH) and some Al powder.

### EXAMPLE 9

### Synthesis of a New Complex Hydride in Tetrahydrofuran from Lithium Aluminum Hydride, Aluminum Powder, Boron Powder, Titanium Chloride and Hydrogen

Step 1. LiAlH₄ and the catalyst precursor (TiCl₃) were mixed in certain proportions. About 1 g of sample was loaded into a 65 cm³ SS vial, along with a single SS ball (8.2 g) having a diameter of 1.3 cm. It was ball milled in this vial for 100 to 120 minutes at room temperature using a SPEX 8000 high-energy ball mill.

Step 2. After ball-milling, the sample was placed in a vial in a glove box as a catalyst.

Step 3. Aluminum powder and boron powder were mixed in certain proportions with above-synthesized catalyst. About 1 g of sample with some solvents (THF, ether etc) was loaded into a 65 cm³ SS vial, along with a single SS ball (8.2 g) having a diameter of 1.3 cm. It was ball milled in this vial for 100 to 120 minutes at room temperature using a SPEX 8000 high-energy ball mill. After ball-milling, the sample was placed in a vial in a glove box.

Step 4. The sample was placed in the constant temperature cycling reactor along with a few drops of THF. The reactor was sealed. The sample was then heated to between 80 and 150° C. under 1400 psig of H₂ and held at these conditions for 3 hours to rehydrogenate it.

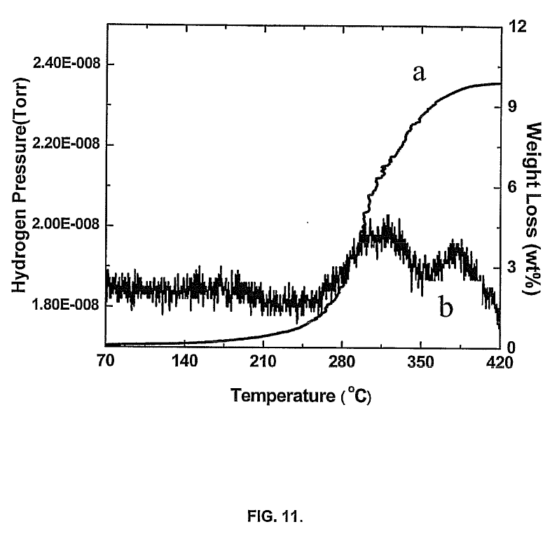

Step 5. The sample was removed from the reactor, taken into the nitrogen glove box, and vacuum dried at 130° C. for 5 hours to remove the THF. A tiny portion (˜20 mg) of the sample was removed for testing. The resulting temperature programmed desorption (TPD) curve is shown in FIG. 11 (curve a), along with an analysis of the discharge gas from a residual gas analyzer (RGA) (curve b).

Step 6. The sample can be cycled by carrying out the dehydrogenation and rehydrogenation steps.

The results in FIG. 11 demonstrate a physiochemical pathway for the synthesis of a new complex hydride at room temperature and a moderate hydrogen pressure according to the procedure outlined in Example 9. These results verify that the procedure outlined in Example 9 foster the synthesis of a new complex hydride comprised of Li, Al and B and hydrogen.

These and other modifications and variations to the present disclosure may be practiced by those of ordinary skill in the art, without departing from the spirit and scope of the present disclosure. For example, the use of certain additives may not be necessary and other additives may be necessary in the physiochemical pathway. Also, it may be possible to eliminate or combine some of the processing steps to further optimize the physiochemical pathway. An important aspect of this disclosure involves placing the discharged complex hydride to be reversed in the presence of some combination of one or more of the following steps: a hydrogen atmosphere, a complex forming solvent, and high energy ball milling (or the equivalent) to foster reversibility. Another important aspect of this disclosure involves starting with metals and metal hydrides of the complex hydride to be synthesized in the presence of some combination of one or more of the following steps: a hydrogen atmosphere, a complex forming solvent, and high energy ball milling (or the equivalent) to foster reversibility. The order in which this pathway is carried out may be tailored to the specific complex hydride. In addition, it should be understood that aspects of the various embodiments may be interchanged both in whole or in part. Furthermore, those of ordinary skill in the art will appreciate that the foregoing description is by way of example only and is not intended to limit the disclosure in any way.

1. A process for cyclic dehydrogenation and rehydrogenation of hydrogen storage materials comprising:
liberating hydrogen from a hydrogen storage material comprising hydrogen atoms chemically bonded to one or more elements to form a dehydrogenated material; and
contacting said dehydrogenated material with a solvent in the presence of hydrogen gas such that said solvent forms a reversible complex with rehydrogenated product of said dehydrogenated material wherein said dehydrogenated material is rehydrogenated to form a solid material containing hydrogen atoms chemically bonded to one or more elements.

2. A process as defined in claim 1, wherein said hydrogen storage material comprises AlH₃, Bₓ(AlH₄)_{y}, Be(AlH₄)₂, Ca(AlH₄)₂, Ce(AlH₄)₂, CuAlH₄, Fe(AlH₄)₂, Ga(AlH₄)₃, In(AlH₄J₃, KAlH₄, LiAlH₄, Mg (AlH₄)₂, Mn(AlH₄)₂, NaAlH₄, Ti(AlH₄)₃, Ti(AlH₄)₄, Sn(AlH₄)₄, Zr(AlH₄)₄, AI(BH₄)₃, Ba(BH₄)₂, Be(BH₄)₂, Ca(BH₄)₂, Cd(BH₄)₂, Co(BH₄)₂, CuBH₄, Fe(BH₄)₂, Hf(BH₄)₄, KBH₄, LiBH₄, Mg(BH₄)₂, RbBH₄, NaBH₄, Sn(BH₄)₂, Sr(BH₄)₂, Na₃AlH₆, Na₂LiAlH₆, Ca₂FeH₆, Ca₄Mg₄Fe₃H₂₂, Mg₆CO₂H₁₁, Mg₂CoH₅, Mg₂FeH₆, LiMg₂RuH₇, Li₄RuH₆, SrMg₂FeH₈, Li₃Be₂H₇, NaMgH₃, LiBeH₃, Li₂BeH₄, LiBeH₄, Li₃Be₂H₅, Na₃RuH₇, Ti(BH₄)₃, U(BH₄)₄, Zn(BH₄)₂, Zr(BH₄)₄, Y(BH₄)₃, Sm(BH₄)₃, Eu(BH₄)₃, Gd(BH₄)₃, Tb(BH₄)₃, Dy(BH₄)₃, Ho(BH₄)₃, Er(BH₄)₃, Tm(BH₄)₃, Yb(BH₄)₃, Lu(BH₄)₃, or combinations thereof.

3. A process as defined in claim 1, wherein said hydrogen storage material comprises an aminoborane, ammonia borane complexes, or combinations thereof.

4. A process as defined in claim 1, wherein said hydrogen storage material comprises a complex hydride material.

5. A process as defined in claim 1, further comprising adding one or more catalysts to said hydrogen storage material.

6. A process as defined in claim 5, wherein said catalyst comprises metal chlorides, metal oxides, metals, or combinations thereof.

7. A process as defined in claim 1, further comprising adding one or more chemical additives to said hydrogen storage material.

8. A process as defined in claim 7, wherein said chemical additive comprises carbon, graphite, single wall carbon nanotubes, multi-wall carbon nanotubes, or combinations thereof.

9. A process as defined in claim 1, further comprising ball milling said hydrogen storage material.

10. A process as defined in claim 1, further comprising heating said hydrogen storage material to a temperature ranging from about 15° C. to about 500° C. to dehydrogenate hydrogen storage material.

11. A process as defined in claim 1, wherein said solvent comprises tetrohydrofuran.

12. A process as defined in claim 1, further comprising ball milling said solvent with said dehydrogenated material in the presence of hydrogen gas such that said dehydrogenated material is rehydrogenated.

13. A process as defined in claim 1, further comprising sonochemically treating said solvent with said dehydrogenated material in the presence of hydrogen gas such that said dehydrogenated material is rehydrogenated.

14. A process as defined in claim 1, further comprising filtering said rehydrogenated material complexed with said solvent.

15. A process as defined in claim 1, further comprising recovering said solvent for reuse during subsequent rehydrogenation cycles.

16. A process as defined in claim 1, wherein said process is utilized to supply hydrogen to an internal combustion engine.

17. A process as defined in claim 1, wherein said process is utilized to supply hydrogen to a fuel cell.

18. A process for synthesis of hydrogen storage materials comprising: providing one or more reactants; and contacting said reactant with a solvent in the presence of hydrogen gas such that said solvent forms a reversible complex with the hydrogenated product of said reactant wherein said reactant is hydrogenated to form a solid material containing hydrogen atoms chemically bonded to one or more elements.

19. A process as defined in claim 18, wherein said hydrogenated storage material comprises AlH₃, Bₓ(AlH₄)_{y}, Be(AlH₄)₂, Ca(AlH₄)₂, Ce(AlH₄)₂, CuAlH₄, Fe(AlH₄)₂, Ga(AlH₄)₃, In(AlH)₃, KAlH₄, LiAlH₄, Mg(AlH₄)₂, Mn(AlH₄)₂, NaAlH₄, Ti(AlH₄)₃, Ti(AlH₄)₄, Sn(AlH₄)₄, Zr(AlH₄)₄, Al(BH₄)₃, Ba(BH₄)₂, Be(BH₄)₂, Ca(BH₄)₂, Cd(BH₄)₂, Co(BH₄)₂, CuBH₄, Fe(BH₄)₂, Hf(BH₄)₄, KBH₄, LiBH₄, Mg(BH₄)₂, RbBH₄, NaBH₄, Sn(BH₄)₂, Sr(BH₄)₂, Na₃AlH₆, Na₂LiAlH₆, Ca₂FeH₆, Ca₄Mg₄Fe₃H₂₂, Mg₆Co₂H₁₁, Mg₂CoH₅, Mg₂FeH₆, LiMg₂RuH₇, Li₄RuH₆, SrMg₂FeH₈, Li₃Be₂H₇, NaMgH₃, LiBeH₃, Li₂BeH₄, LiBeH₄, Li₃Be₂H₅, Na₃RuH₇, Ti(BH₄)₃, U(BH₄)₄, Zn(BH₄)₂, Zr(BH₄)₄, Y(BH₄)₃, Sm(BH₄)₃, Eu(BH₄)₃, Gd(BH₄)₃, Tb(BH₄)₃, Dy(BH₄)₃, Ho(BH₄)₃, Er(BH₄)₃, Tm(BH₄)₃, Yb(BH₄)₃, Lu(BH₄)₃, or combinations thereof.

20. A process as defined in claim 18, further comprising adding one or more catalysts to said reactants.

21. A process as defined in claim 20, wherein said catalyst comprises a metal chloride, metal oxides, metals, or combinations thereof.

22. A process as defined in claim 18, further comprising adding one or more chemical additives to said reactants.

23. A process as defined in claim 22, wherein said chemical additive comprises graphite, single wall carbon nanotubes, multi-wall carbon nanotubes, or combinations thereof.

24. A process as defined in claim 18, wherein said solvent comprises tetrohydrofuran.

25. A process as defined in claim 18, further comprising ball milling said reactants in the presence of hydrogen gas such that said reactants are hydrogenated.

26. A process as defined in claim 18, further comprising sonochemically treating said reactants in the presence of hydrogen gas such that said reactants are hydrogenated.

27. A process as defined in claim 18, further comprising filtering said hydrogenated complex.

28. A process as defined in claim 18, wherein said process can be utilized to supply hydrogen to an internal combustion engine.

29. A process as defined in claim 18, wherein said process can be utilized to supply hydrogen to a fuel cell.
